(19) United States
(12) Patent Application Publication
(10) Pub. No.: US 2018/0204519 A1
(43) Pub. Date: Jul. 19, 2018

(54) DISPLAY PANEL DEVICE

(71) Applicant: EverDisplay Optronics (Shanghai) Limited, Shanghai (CN)

(72) Inventors: XIAOLI XU, Shanghai (CN); Sisi ZHOU, Shanghai (CN)

(73) Assignee: EverDisplay Optronics (Shanghai) Limited, Shanghai (CN)

(21) Appl. No.: 15/865,752

(22) Filed: Jan. 9, 2018

(30) Foreign Application Priority Data
Jan. 17, 2017 (CN) 201710036370.4

(51) Int. Cl. G09G 3/3258

(52) U.S. Cl. CPC G09G 3/3258; G09G 2310/0264

(57) ABSTRACT

A display device includes a pixel array and a plurality of data lines for providing a data voltage signal for a sub-pixel unit in the pixel array, wherein each data line corresponds to a predefined series of sub-pixel units of each row of the pixel array and provides the data voltage signal to the predefined series of sub-pixel units, wherein the predefined series of sub-pixel units comprises a plurality of sub-pixel units.

### CROSS-REFERENCE TO RELATED APPLICATIONS

The present application claims priority to and the benefit of Chinese Patent Application No. CN 201710036370.4, filed on Jan. 17, 2017, the entire content of which is incorporated herein by reference.

### FIGURE FOR PUBLICATION

FIG. 2

### BACKGROUND OF THE INVENTION

### 1. Field of the Disclosure

The disclosure relates to the panel display, more particularly, to an AMOLED display panel device.

### 2. Background

Compared to a display product with a large size and a high resolution, a display product having a small size and a low resolution has a large reduction in the number of rows in the pixel array of the display, and each row of pixels essentially has a relatively abundant signal refresh time when the image refresh frequency is identical, so that the signal scan time per pixel can be appropriately reduced. In addition, as the small size display products has a small size, the local area for containing and placing the battery is very limited, so that the overall power consumption of the product system is considered. If we can reduce the number of the data lines that drive the pixel array, the number of ports of the driver chip can be greatly reduced. Specifically, as the total power consumption of the display panel is fixed, reducing the output ports of the driver chip can effectively reduce the power consumption of the driver chip, while the size and cost of the driver chip is reduced as the output ports is reduced. However, how to greatly reduce the number of ports of signal lines, and reduce the number of voltage sources corresponding to the signal lines, in order to effectively reduce the driver chip power consumption, and reduce the development cycle and development costs, is still one of the problems we are facing.

### ASPECT AND SUMMARY OF THE INVENTION

An optional embodiment of the present disclosure provides a display device, comprising a pixel array and a plurality of data lines for applying data voltage signals to sub-pixel units in the pixel array, wherein each of the data lines is configured for applying a data voltage to a predefined series of the sub-pixel units in the pixel array, and the predefined series of the sub-pixel units comprises a plurality of the sub-pixel units.

### BRIEF DESCRIPTIONS OF THE DRAWINGS

FIG. 1 is a traditional display panel device showing the basic architecture in which a signal line corresponds to a column of pixels.

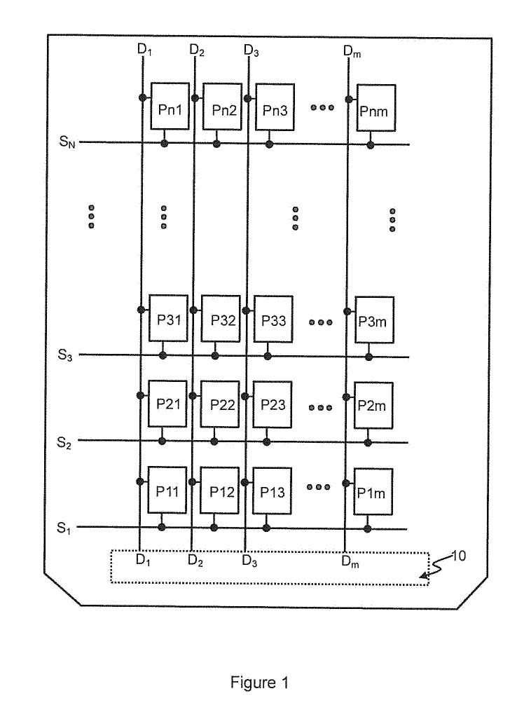

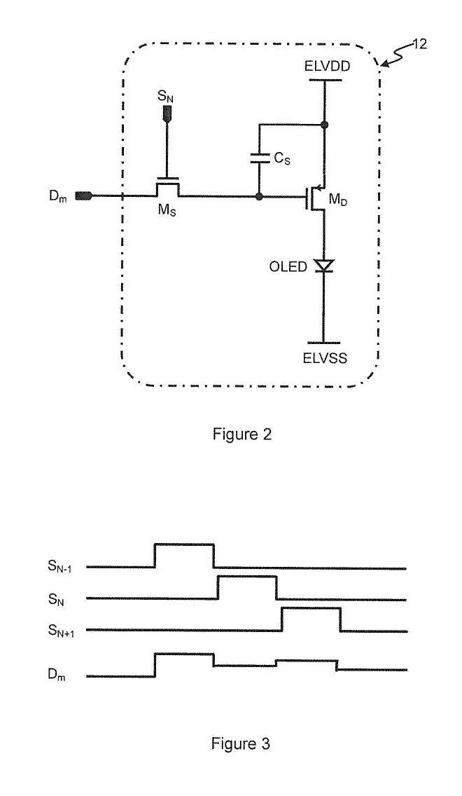

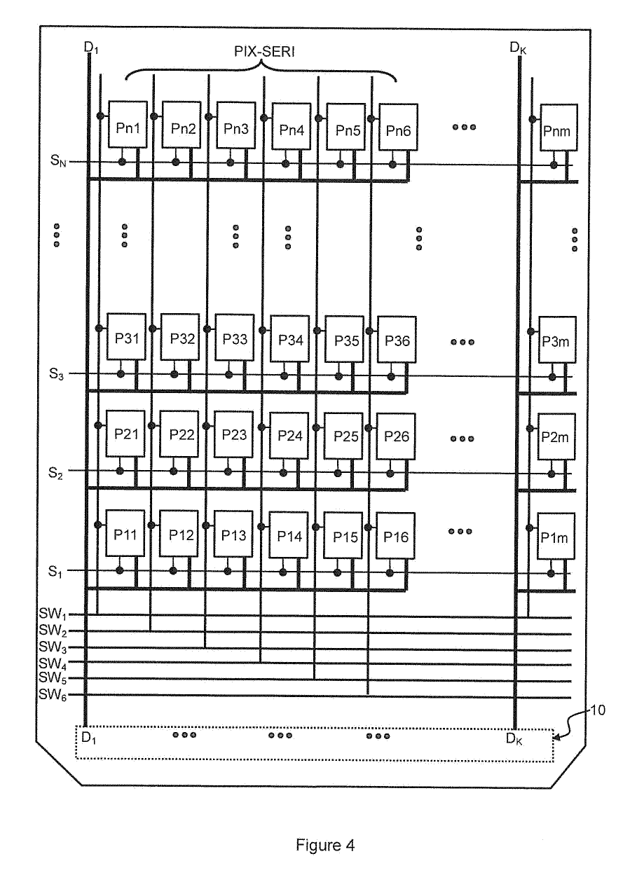

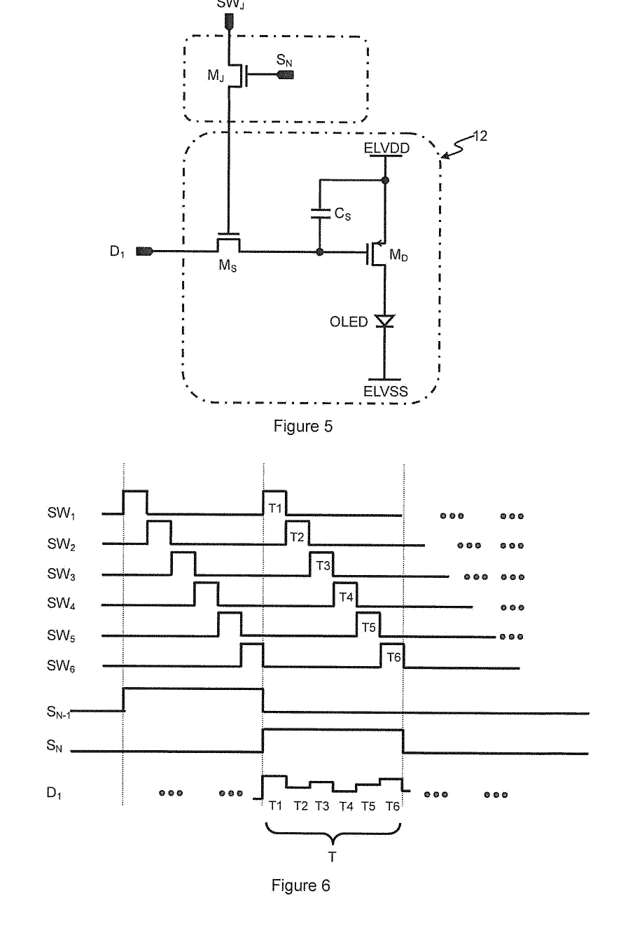

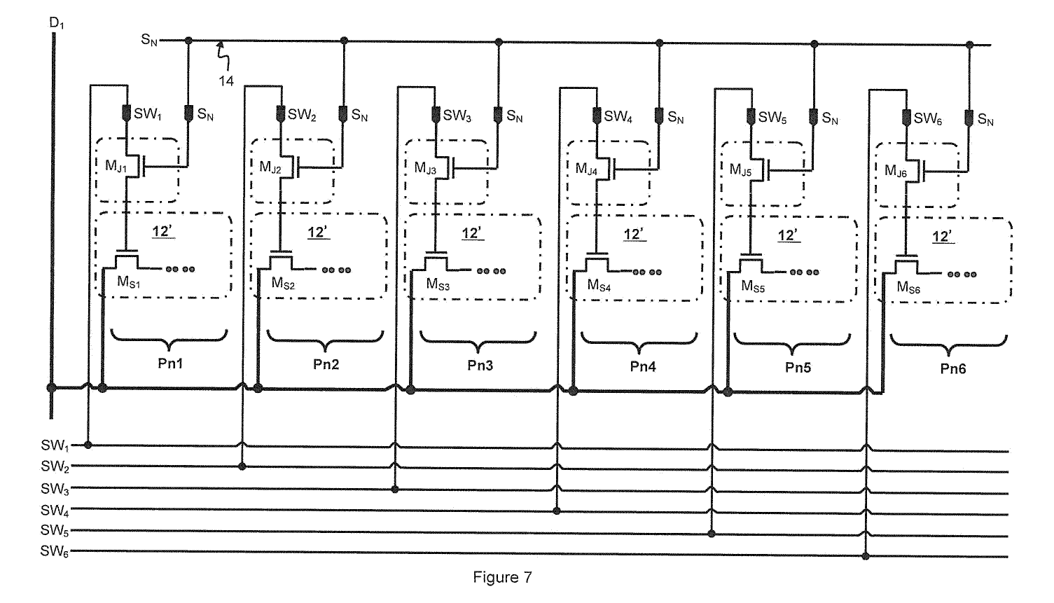

FIG. 2 illustrates a pixel circuit of a 2T1C circuit structure with the disclosed embodiments.

FIG. 3 is a schematic diagram of a timing control of the pixel circuit of the 2T1C circuit structure with the disclosed embodiments.

FIG. 4 is a display device showing the basic configuration in which a signal line corresponds to a plurality of columns of pixels with the disclosed embodiments.

FIG. 5 is a schematic circuit diagram of a display device with the disclosed embodiments.

FIG. 6 is a schematic diagram of a timing control of a display device with the disclosed embodiments.

FIG. 7 is a circuit diagram of predefined series of sub-pixel units of each roe of the pixel array of a display device with the disclosed embodiments.

### DETAILED DESCRIPTION OF THE INVENTION

The present disclosure will now he described more fully hereinafter with reference to the accompanying drawings, in which exemplary embodiments of the disclosure are shown. This disclosure may, however, be embodied in many different forms and should not be construed as limited to the embodiments set forth herein. Rather, these embodiments are provided so that this disclosure will be thorough and complete, and will fully convey the scope of the disclosure to those skilled in the art. Like reference numerals refer to like elements throughout.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not he interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the term “plurality” means a number greater than one.

Hereinafter, certain exemplary embodiments according to the present disclosure will be described with reference to the accompanying drawings.

As referred to FIG. 1, the display device is generally embodied in an array and the array has multiple rows of sub-pixel units and multiple columns of sub-pixel units. For example, the array as shown in FIG. 1, has multiple rows of sub-pixel units, such as the first row P11, P12, P13, . . . , P1m and the second row P21, P22, P23, . . . , P2m, and so on, till to the n^{th} row Pn1, Pn2, Pn3 . . . Pnm, etc. Corresponding to the multi-row sub-pixel units, the array also has multiple columns of sub-pixel units, such as the first column P11, P21, P31 . . . Pn1 and the second column P12, P22, P32 . . . Pn2, and so on, till to the m^{th} column P1m, P2m, P3m, . . . , Pnm, etc. The number of columns M and the number of rows N of the array are all natural number greater than one, and the context hereafter will introduce the present disclosure in an array.

As referred to FIG. 1, in the panel display area, a data line provided by a driver chip 10 or the equivalent driving device is usually used to cooperate with all the sub-pixel units of a column in the array. For example, the first data line D₁ provides the data voltage signal VDATA to all of the sub-pixel units P11, P21, P31, . . . , Pn1 of the first column, the second data line D₂ provides the data voltage signal V_{DATA} to all of the sub-pixel units P12, P22, P32, . . . , Pn2 of the second column, and so on, the m^{th} data line Dₘ provides the data voltage signal V_{DATA} to all of the sub-pixel units P1m, P2m, P3m . . . Pnm of the m^{th} column. Each row is shared with scanning line, for example, the first scanning line provides the scanning signal S₁ to all of the sub-pixel units P11, P12, P13, . . . , P1m of the first row, the second scanning line provides the scanning signal S₂ to all of the sub-pixels P21, P22, P23, . . . , P2m of the second row, and so on, and the n^{th} scan line provides the scanning signal S_{N} to all of the sub-pixel units Pn1, Pn2, Pn3, . . . Pnm of the n^{th} row.

It is easy to see from the above disclosure that, in FIG. 1, the number of columns of sub-pixel unit is equal to the number of data lines. The number of data lines being equal to the number of columns will undoubtedly lead to the significant number of the output port of the driver chip 10, thus it is adverse to reduce the product size and the power consumption. One of the spirits of the disclosure is to overcome this concern and to avoid introducing too many data lines.

As referred to FIG. 2, in order to explain the present application clearly, it will take a typical 2T1C pixel circuit 12 as an example. Although to present disclosure has been described with the 2T1C pixel circuit 12 as an example, but this does not mean that the present application is limited to the 2T1C pixel circuit 12. In essence, the reader of this context should be aware that any pixel circuit that utilizes the data line to provide a data voltage signal to achieve light emission of the light emitting diode device is suitable for the solution in the present disclosure, and typically the pixel circuits in the following documents: U.S. Patent Application US20110227893, U.S. Pat. No. 6,847,340, and the like, or the Chinese patent application CN104036714A, are also applicable to the inventive spirit of the present disclosure.

In the 2T1C sub-pixel unit or pixel circuit 12 as shown in FIG. 2, a PMOS channel type thin film TFT drives transistor M_{D}, and an OLED light emitting diode is connected in series between a first power supply voltage VDD (ELVDD in the figure) with a high potential and a second supply voltage VSS (ELVSS in the figure) with a low potential. One end of one storage capacitor C_{S} is connected to the gate control terminal of the driving transistor M_{D}, and the opposite end of the storage capacitor C_{S} is connected to the source of the driving transistor M_{D} coupled to the first power supply voltage VDD, and the drain of the driving transistor M_{D} is connected to the anode of the light emitting diode, the cathode of the light emitting diode is connected to the second power supply voltage VSS. A gate transistor M_{S} is connected between the data voltage signal input terminal Data Input of the 2T1C pixel circuit 12 and the gate of the driving transistor M_{D}. The gate of the transistor M_{S} is controlled by the scanning signal S_{N}, for example, when the scanning signal S_{N} is at the high level, the data voltage signal Dₘ supplied from the driver chip is transferred to one end of the storage capacitor C_{S} via the turn-on transistor M_{S} to implement the data writing, in which one end of the storage capacitor C_{S} is connected to the gate of the transistor M_{D}, and the data voltage signal is kept stable by the storage capacitor C_{S} in one frame time, when the scanning signal S_{N} is high in the next time, the above operation is repeated again. In the timing control of FIG. 3, in the entire array, for example, the scanning signal S_{N-1} of the preceding row, the scanning signal S_{N} of the current row, and the scanning signal S_{N+1} of the subsequent row are shifted step by step, when the scanning signal S_{N-1} is in the active logic state (e.g., the high level), the pixel circuit 12 of the N−1^{th} row implements the writing of the data voltage signal and then the scanning signal S_{N-1} returns to the low level. When the scanning signal S_{N} is in the active logic state (e.g., the high level), the pixel circuit 12 of the N^{th} row implements the writing of the data voltage signal and then the scanning, signal S_{N} returns to the low level. When the scanning signal S_{N+1} is in the active logic state (e.g., a high level), pixel circuit 12 of the N+1^{th} row implements the writing of the data voltage signal and then the scanning signal S_{N+1} is returned to the low level, and so on. Whereby the light emission and display of the light emitting diode are realized. Here, the type of the gate transistor M_{S} is merely a demonstration and is not a limiting condition, for example, if the gate transistor M_{S} is NMOS, it is turned on when the scanning signal S_{N} is at a high level, and vice versa. If the gate transistor M_{S} is PMOS, it is turned on when the scanning signal S_{N} is at a low level.

Since the spirit of the application resides in how to provide a way to provide a data voltage signal to a pixel circuit with less data lines rather than what circuit architecture the pixel circuit itself being. For example, as referred to FIG. 2, the first end of the gated transistor M_{S} receives the data voltage signal Dₘ and when it is turned on the second end of the gated transistor M_{S} can output the data voltage signal Dₘ. On the contrary, when the gated transistor M_{S} is turned off the second end thereof cannot output data voltage signal Dₘ, so that it is applicable to any sub-pixel unit or pixel circuit as long as they meet the rule. With respect to the type of specific pixel circuit to which the second end of the gate transistor M_{S} is connected in FIG. 2, the present disclosure does not care, and the reader, can assume that the 2T1C pixel circuit 12 here can be used as a substitute for any alternative pixel circuit, or sub-pixel unit, the spirit of the disclosure should be fully respected upon reading the scope of this document or the scope of the claims.

FIG. 4 shows a display device disclosed in the present disclosure, the display device comprises a pixel array and a plurality of data lines D₁, D₂, . . . , D_{K} for supplying a data voltage signal V_{DATA} for a sub-pixel unit Sub-Pixel in the pixel array, wherein the value K is a natural number greater than one, and the plurality of data lines D₁, D₂, . . . , D_{K} correspond to a plurality of output ports connected to the driver chip 10. Unlike to conventional scheme of a data line corresponding to a column of sub-pixel unit in the prior art, the technical solution of the present disclosure requires that each individual data line is used for providing a data voltage signal to a predefined series of sub-pixel units PIX-SERI of any row of a pixel array Pixels-Array, and wherein the predefined series of sub-pixel units PIX-SERI should contain a plurality of sub-pixel units, rather than only a single sub-pixel unit.

As referred to FIG. 4, for example, the predefined series of sub-pixel units PIX-SERI of n^{th} row of a pixel array is taken as an example, and the first data line D₁ provides the data voltage signal to the predefined series of sub-pixel units PIX-SERI. For the sake of description, we briefly assumes that the predefined series of sub-pixel units PIX-SERI comprises six sub-pixel units, but substantially six is merely an example and does not constitute any particular limitation. If necessary, the number of sub-pixel units included in the predefined series of sub-pixel units PIX-SERI may he optional.

In the pixel array mentioned above, if we analyze the pixel array in view of the row, the first data line D₁ (shown by a thicker black line) is connected to each of the first row of predefined series of sub-pixel units PIX-SERI {P11, P12, P13, P14, P15, P16}, and the first data line D₁ is also connected to each of the second row of predefined series of sub-pixel units PIX-SERI {P21 , P22, P23, P24, P25, P26}, and so on, till the first data line D₁ is connected to each of the n^{th} row of predefined series of sub-pixel units PIX-SERI {Pn1, Pn2, Pn3, Pn4, Pn5, Pn6}, which has six sub-pixel units. Therefore, if we inspect the pixel array in view of row, it is obvious that the rule is: all first six sub-pixel units of the row, which are from the first row to the n^{th} row, are connected to the first data line D₁.

In the pixel array mentioned above, if we analyze the pixel array in view of the column, the first data line D₁ is connected to all pixel units {P11, P21, . . . , Pn1} of the first column, and the first data line D₁ is also connected to all pixel units {P12, P22, . . . , Pn2} of the second column, and so on, till the first data line D₁ is connected to all pixel units {P16, P26, . . . , Pn6} of the six column. Therefore, if we inspect the pixel array in view of column, it is obvious that the rule is: all sub-pixel units of the column, which are from the first column to the 6^{th} column, are connected to the first data line D₁.

It is noted that the selection of the first data line D₁ here is just an example for the convenience of the explanation and does not constitute any particular limitation. For example, the rule of row connection of the second data line D₂ is: the 7^{th}-12^{th} sub-pixel units of the row, which are from the first row to the n^{th} row, are connected to the first data line D₂; the rule of column connection of the second data line D₂ is: the 7^{th}-12^{th} sub-pixel units of the column, which are from the 7^{th} column to the 12^{th} column, are connected to the first data line D₂. Subsequently, the third data lines D₃, . . . , to K^{th} data lines D_{K} follow the same rule.

As referred to FIG. 5, the sub-pixel unit or the pixel circuit 12 of 2T1C is still described as an example. The first end of the gate transistor M_{S} (named as the first transistor) is connected to the first data line D₁, and the second end of the gate transistor M_{S} supplies the data voltage signal to the pixel circuit 12 or the similar sub-pixel unit, and the data voltage signal on the first data line D₁ can be transmitted to the pixel circuit 12 or the similar sub-pixel unit via the gate transistor M_{S} only when the gate transistor M_{S} is turned on. On the contrary, the data voltage signal on the first data line D₁ cannot be transmitted to the pixel circuit 12 or the similar sub-pixel unit via the gate transistor M_{S} when the gate transistor M_{S} is turned off. In the embodiment, the control end of the gate transistor M_{S} is connected to the second end of a second transistor M_{J}, the first end of the second transistor M_{J} is used for inputting a timing control signal SW_{J}, and the control end of the second transistor M_{J} is coupled to and driven by the scanning signal S_{N}. The operation mechanism of the circuit is that, when the scanning signal S_{N} controls the second transistor M_{J} to turn off, the timing control signal SW_{J} cannot be transmitted to the control end of the gate transistor M_{S}, and only when the scanning signal S_{N} controls the second transistor M_{J} to turn on, the timing control signal SW_{J} can be transmitted to the control end of the gate transistor M_{S} via the turn-on second transistor M_{J}, and the timing control signal SW_{J} which is switched between the high level and the low level can further drive and control the gate transistor M_{S} to be turned on or turned off.

The gate transistor M_{S} (the first transistor), the second transistor M_{J}, wherein if first end thereof is, for example, a drain (or source), the second end thereof is, for example, a source (or a drain), and the control end thereof is, for example, a gate. To act as electronic switches, the control end thereof can control whether the connection between the first and second ends are turned on or turned off. And if the second transistor M_{J} is an NMOS transistor, the second transistor M_{J} is turned on only when the scanning signal S_{N} is in the active logic state with the high level (when the scanning signal S_{N} is low level the second transistor M_{J} is turned off), and vice versa, if the second transistor M_{J} is the PMOS transistor, the second transistor M_{J} is turned on only when the scanning signal S_{N} is in the active state with the low level (when the scanning signal S_{N} is high level the second transistor M_{J} is turned off). As discussed above, the timing control signal SW_{J} can be coupled to the control end of the gate transistor M_{S} only if the second transistor M_{J} is turned on. In this case, if the gate transistor M_{S} is an NMOS transistor, only when the timing control signal SW_{J} is in the active logic state with the high level, the gate transistor M_{S} is timed on (when the timing control signal SW_{J} is low level the gate transistor M_{S} is turned off), and vice versa, if the gate transistor M_{S} is the PMOS transistor, only when the timing control signal SW_{J} is in the active logic state with the low level, the gate transistor M_{S} is turned on (when the timing control signal SW_{J} is high level the gate transistor M_{S} is turned off). If the second transistor M_{J} is turned off, the gate transistor M_{S} remains in the turn-off state.

The 2T1C sub-pixel unit or pixel circuit 12 in FIG. 5 may be applied to the pixel array of FIG. 4, and may be driven by the operation timing in FIG. 6. But we take the six sub-pixel units, the n^{th} row of predefined series of sub-pixel units PIX-SERI {Pn1, Pn2, Pn3, Pn4, Pn5, Pn6} selected in the pixel array in FIG. 7, as an example to explain the control mode of this tuning of the present disclosure, and in FIG. 7, the pixel circuit 12′ of each sub-pixel unit may be of any type without being limited to the 2T1C model.

As shown in FIG. 7, the first ends of the first transistors M_{S1}, M_{S2}, M_{S3}, M_{S4}, M_{S5}, and M_{S6} in the respective sub-pixel units Pn1, Pn2, Pn3, Pn4, Pn5, and Pn6 are uniformly connected to the first data line D₁, and the data voltage signal is input from the first data line D₁. When the first transistor M_{S1} in the sub-pixel unit Pn1 is turned on, the data voltage signal can be provided to the sub-pixel unit Pn1 through the second end of the first transistor M_{S1}. Likewise, when the first transistor M_{S2} in the sub-pixel unit Pn2 is turned on, the data voltage signal can be provided to the sub-pixel unit Pn2 through the second end of the first transistor M_{S2}, and so on, . . . , when the first transistor M_{S6} in the sub-pixel unit Pn6 is turned on, the data voltage signal can be provided to the sub-pixel unit Pn6 through the second end of the first transistor M_{S6}.

As referred to FIGS. 6 and 7, the driving mechanism of the set of timing control signals SW₁ to SW₆ will be described later. In the sub-pixel unit Pn1, the first end of the second transistor M_{J1} is input with the timing control signal SW₁, and the second end of the second transistor M_{J1} is connected to the control end of the first transistor M_{S1} in the sub-pixel unit Pn1. In the sub-pixel unit Pn2, the first end of the second transistor M_{J2} is input with the timing control signal SW₂, and the second end of the second transistor M_{J2} is connected to the control end of the first transistor M_{S2} in the sub-pixel unit Pn2. In the sub-pixel unit Pn3, the first end of the second transistor M_{J3} is input with the timing control signal SW₃, and the second end of the second transistor M_{J3} is connected to the control end of the first transistor M_{S3} in the sub-pixel unit Pn3. In the sub-pixel unit Pn4, the first end of the second transistor M_{J4} is input with the timing control signal SW₄, and the second end of the second transistor M_{J4} is connected to the control end of the first transistor M_{S4} in the sub-pixel unit Pn4. In the sub-pixel unit Pn5, the first end of the second transistor M_{J5} is input with the timing control signal SW₅, and the second end of the second transistor M_{J5} is connected to the control end of the first transistor M_{S5} in the sub-pixel unit Pn5. In the sub-pixel unit Pn6, the first end, of the second transistor M_{J6} is input with the timing control signal SW₆, and the second end of the second transistor M_{J6} is connected to the control end of the first transistor M_{S6} in the sub-pixel unit Pn6.

As referred to FIG. 7, among the predefined series of sub-pixel units PIX-SERI, the control ends of the respective second transistors M_{J1}, M_{J2}, M_{J3}, M_{J4}, M_{J5}, and M_{J6} in all the sub-pixel units Pn1, Pn2, Pn3, Pn4, Pn5, and Pn6 are simultaneously connected to a scan line 14 of the row (i.e., n^{th} row) of the predefined series of sub-pixel units PIX-SERI, so that the control ends of the second transistors M_{J1} to M_{J6} simultaneously receive the same scanning signal S_{N} which is input to the scan line 14.

As referred to FIGS. 6 and 7, when the scanning signal S_{N} coupled to scan line 14 of the row of the predefined series of sub-pixel units PIX-SERI is at the stage of active logic state (e.g., high level), this stage is shown as a period T in FIG. 6, all of the second transistors M_{J1}, M_{J2}, M_{J3}, M_{J4}, M_{J5}, M_{J6} are turned on, and at this stage, a series of timing control signals SW₁, SW₂, SW₃, S W₄, SW₅, SW₆ are sequentially inverted from the second logic level (e.g., low level) to the first logic level (e.g., high level), and then returned to the second logic level. Note that a set of timing control signals SW₁ to SW₆ are non-overlapping timings, which means that after the previous timing control signal jumps from the first logic level to the second logic level, the adjacent subsequent tuning control signal will jump from the second logic level to the first logic level, the previous and the subsequent timing control signal do not overlap each other. The following will explain the timing of the working mechanism in a number of stages T1 to T6 over the entire period T.

In the period T, the timing control signal SW₁ is turned on to the high level in the first stage T1 so that the first transistor M_{S1} is turned on, and the sub-pixel unit Pn1 can extract the data voltage signal from the first data line D₁ through the first transistor M_{S1}, the data voltage signal stored in the sub-pixel unit Pn1 may be used to illuminate the light emitting diode, for example, the OLED of the red color R, and the timing control signal SW₁ is turned back to the low level after the first stage T1 is finished.

After the end of the first stage T1, it comes the second stage T2, in which the timing control signal SW₂ starts to turn over to the high level, to turn on the first transistor M_{S2}, and the sub-pixel unit Pn2 can extract the data voltage signal from the first data line D₁ through the first transistor M_{S2}. The data voltage signal stored in the sub-pixel unit Pn2 can be used to illuminate the light emitting diode, for example, the OLED of the green color G, and the timing control signal SW₂ is turned back to the low level after the second stage T2 is finished.

After the end of the second stage T2, it comes the third stage T3, in which the timing control signal SW₃ starts to turn over to the high level, to turn on the first transistor M_{S3}, and the sub-pixel unit Pn3 can extract the data voltage signal from the first data line D₁ through the first transistor M_{S3}. The data voltage signal stored in the sub-pixel unit Pn3 can be used to illuminate the light emitting diode, for example, the OLED of the blue color B, and the timing control signal SW₃ is turned back to the low level after the third stage T3 is finished.

After the end of the third stage T3, it comes the fourth stage T4, in which the timing control signal SW₄ starts to turn over to the high level, to turn on the first transistor M_{S4}, and the sub-pixel unit Pn4 can extract the data voltage signal from the first data line D₁ through the first transistor M_{S4}. The data voltage signal stored in the sub-pixel unit Pn4 can be used to illuminate the light emitting diode, for example, the OLED of the red color R, and the timing control signal SW₄ is turned back to the low level after the fourth stage T4 is finished.

And so on, after the end of the fourth stage T4, it comes the fifth stage T5, in which the timing control signal SW₅ starts to turn over to the high level, to turn on the first transistor M_{S5}, and the sub-pixel unit Pn5 can extract the data voltage signal from the first data line D₁ through the first transistor M_{S5}. The data voltage signal stored in the sub-pixel unit Pn5 can be used to illuminate the light emitting diode, for example, the OLED of the green color G, and the timing control signal SW₅ is turned back to the low level after the fifth stage T5 is finished.

After the end of the fifth stage T5, it comes the sixth stage T6, in which the timing control signal SW₆ starts to turn over to the high level, to turn on the first transistor M_{S5}, and the sub-pixel unit Pn6 can extract the data voltage signal from the first data line D₁ through the first transistor M_{S6}. The data voltage signal stored in the sub-pixel unit Pn6 can be used to illuminate the light emitting diode, for example, the OLED of the blue color B, and the timing control signal SW₆ is turned back to the low level after the sixth stage T6 is finished.

It can be learned from the timing of FIG. 6 and the pixel array architecture of FIG. 7 that, the scanning signal S_{N} turns over from the second logic level (e.g., low level) which makes the second transistor turn off to the first logic level (e.g., high level) which is at the active logic state, so as to turn on the second transistor. Then the scanning signal S_{N} is turned over to the second logic level after the end of the T period, and turn off the second transistor. More importantly, the desired R/G/B-R/G/B illuminating order is achieved from the six stages T1 to T6 over the entire period T.

As referred to FIG. 4, another rule disclosed in the present disclosure is that, in the pixel array, all of the sub-pixel units in the respective column (the first column to the sixth column) of the sub-pixel units {Pn1, Pn2, Pn3, Pn4, Pn5, Pn6} of each row (e.g., n^{th} row) of the predefined series of sub-pixel units PIX-SERI {Pn1, Pn2, Pn3, Pn4, Pn5, Pn6} are supplied with the data voltage signal by the same first data line D₁. That is, the sub-pixels P11 to Pn1 of the first column, the sub-pixels P12 to Pn2 of the second column, the sub-pixels P13 to Pn3 of the third column, the sub-pixels P14 to Pn4 of the fourth column, the sub-pixels P15 to Pn5 of the fifth column, the sub-pixels P16 to Pn6 of the sixth column, all the sub-pixel units in the six columns are supplied with the data voltage signal by the same first data line D₁. In other words, the one-to-one connection relationship between the data line and the pixel column adopted by the traditional solution is replaced by the one-to-multi/many connection relationship between the data line and the pixel columns adopted by the disclosure.

The disclosure proposes a display driving solution, in which a signal line corresponds to a multi-column pixel without changing the structure of the original panel circuit, and adds an additional switch TFT on the Gate control line of the switching TFT of the Data input terminal of the original pixel circuit. By the timing control signal design, the disclosure greatly reduces the overall number of signal lines and the number of the driver chip output port, thus the development cost of the driver chip is effectively reduced, the overall power consumption of the system is reduced, and it is especially suitable for portable electronic devices and a variety of display devices with small size.

The foregoing is only the preferred embodiments of the disclosure, not thus limiting embodiments and scope of the disclosure, those skilled in the art should be able to realize that the schemes obtained from the content of specification and figures of the disclosure are within the scope of the disclosure.

What is claimed is:

1. A display device, comprising a pixel array and a plurality of data lines for applying data voltage signals to sub-pixel units in the pixel array, wherein each of the data lines is configured for applying a data voltage to a predefined series of the sub-pixel units in the pixel array, and the predefined series of the sub-pixel units comprises a plurality of the sub-pixel units.

2. The display device according to claim 1, wherein: whether the data voltage signal is applied to the predefined series of the sub-pixel units is controlled by a set of timing control signals and a scanning signal, when the scanning signal and one of the set of timing control signals are at a preset active logic state, a sub-pixel circuit controlled by the one of the set of timing control signals and the scanning signal in the predefined series of the sub-pixel units can receive the data voltage signal.

3. The display device according to claim 2, wherein: each of the sub-pixel units includes a first transistor and a second transistor, both the first transistor and the second transistor have a control terminal, a first terminal and a second terminal, wherein, in the predefined series of the sub-pixel units;
all of the first terminals of the first transistors of the sub-pixel units are connected to the same data line, and in a stage that the first transistor is turned on the second terminal of the first transistor in each of the sub-pixel units provides the data voltage signal to the sub-pixel circuit; and
wherein the first terminal of the second transistor of each of the sub-pixel units receives one of the set of the timing control signals, and the second terminal of the second transistor is connected to the control terminal of the first transistor of one of the sub-pixel units; and
all of the control terminals of the second transistors of the sub-pixel units are connected to a scanning line of a row of the pixel array in which the predefined series of sub-pixel units are located to receive a same scanning signal.

4. The display device according to claim 2, wherein: the active logic state is a first logic level, in a stage that the scanning signal is at the active logic state, the set of timing control signals is, in chronological sequence, turned over to the first logic level and then returned back to the second logic level, such that the sub-pixel units comprised in the predefined series of sub-pixel units receive the data voltage signals in sequence.

5. The display device according to claim 3, wherein: the active logic state is a first logic level, in a stage that the scanning signal coupled to the scanning line of the row of the pixel array in which the predefined series of sub-pixel units is located is at the active logic state, the second transistor of each one of the sub-pixel units of the predefined series of sub-pixel units is turned on, and in this stage, the set of timing control signals, in chronological sequence, is turned over to the first logic level and then returned back to the second logic level;
whereby a series of the first transistors comprised in the sub-pixel units of the predefined series of sub-pixel units is, in sequence, turned on and then turned off, so that the sub-pixel units comprised in the predefined series of sub-pixel units receive the data voltage signals in sequence.

6. The display device according to claim 4, wherein: the first logic level is a logic thigh level and the second logic level is a logic low level.

7. The display device according to claim 5, wherein: the first logic level is a logic high level and the second logic level is a logic low level.

8. The display device according to claim 1, wherein: in the pixel array, all of the sub-pixel units in a column of the pixel array in which each one of the sub pixel units of the predefined series of sub-pixel units in each row of the pixel array locates are provided with the data voltage signals from a same data line.

9. The display device according to claim 1, wherein: in the pixel array, all of the sub-pixel units in a plurality of columns of the pixel array in which each of the sub-pixel units of the predefined series of sub-pixel units in each row of the pixel array locates are applied with the data voltage signals from a same data line.

10. The display device according to claim 1, wherein: numbers of the sub-pixel units of each of the predefined series of sub-pixel units are equal.

11. The display device according to claim 2, wherein: once a previous one of the set of timing control signals is returned back to the second logic level, a latter one of the set of timing control signals is immediately turned to the first logic level.
